(19) United States
(12) Patent Application Publication
(10) Pub. No.: US 2009/0137429 A1
(43) Pub. Date: May 28, 2009

(54) Temperature-Extended Enzyme Systems

(76) Inventors: Shawn McCleskey Rimassa, Houston, TX (US); Mathew Samuel, Sugar Land, TX (US); Steve Mason, Katy, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/945,045

(22) Filed: Nov. 26, 2007

(51) Int. Cl. C09K 8/524

(52) U.S. Cl. 507/201

(57) ABSTRACT

Water-soluble amphoteric surfactants at low concentration thermostabilize enzymes in brine. The thermostabilized enzyme compositions can be used in a method to digest polymers at temperatures and/or salinities at which the enzyme is normally inactivated and/or coagulated without the surfactant. In oilfield applications, the composition can be used in well treatment methods including filtercake removal and polymer viscosity breaking in well treatment fluids.

### TECHNICAL FIELD OF THE INVENTION

This invention relates to enzyme systems and methods applicable to high brine and/or high temperature environments, more particularly to treatment fluids and methods involving the enzymatic breakdown of polymers, and especially in oilfield applications such as filtercake removal, breaking polymer viscosity in fracturing fluids, and so on.

### BACKGROUND OF THE INVENTION

The statements in this section merely provide background information related to the present disclosure and may not constitute prior art.

Hydraulic fracturing and gravel packing require the use of viscosified fluids to suspend or transport the gravel or proppant. However, whenever polymeric viscosifiers are used some degree of formation damage is created which requires removal to optimize oil and gas production and recovery. Therefore breakers, such as enzymes, are frequently employed to reduce or remove the effects of formation damage.

Proppant and gravel are natural or synthetic materials, which may be the same or different. Gravel packing is used for sand control, i.e., to prevent production of formation sand, usually by placing a steel screen in the wellbore and packing the surrounding annulus with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations to be hydraulically fractured are frequently poorly consolidated, so sand control is also needed. Therefore, hydraulic fracturing treatments in which short, wide fractures are wanted are often combined in a single continuous operation with gravel packing.

Another sand control technique uses polymeric fluids in a “kill pill” or “fluid loss pill” to control fluid loss to a subterranean formation. Kill pills are composed of sized particles in a carrier fluid that are designed to form an effective bridge across the pore throats of the reservoir or crosslinked polymer systems, and may also be used to form a seal against the formation face. These fluid loss pills can cause severe damage to near-wellbore areas and limit production potential of a wellbore.

Most polymeric fluids used in oilfield applications damage the formation by leaving behind a filtercake used to control fluid leak-off into the formation and to restrict the inflow of reservoir fluids into the formation rock during drilling and completion techniques. If the filtercake damage is not removed prior to or during completion of the well, a range of issues can arise, for example, completion equipment failures, impaired reservoir productivity, and so on.

The major components typically found in filtercakes can include polymers, such as starch and xanthan gum, and solids, such as carbonates and other inorganic salts and clays. The solids in the mud are sized such that they can form an efficient bridge across the pores of the formation rock as it is being drilled. As the solids in the mud develop bridges across the exposed pores or pore throats of the reservoir, the polymeric fluid loss material from the mud can be co-deposited within the interstices of the solid bridging particles, thus sealing off the reservoir from the wellbore. These polymeric materials can comprise an integral component of the resulting filtercake, typically 17 to 20 weight percent of the dry filtercake, and can be responsible for the ultra low permeability of the filtercake.

Cleanup of polymer-based filter cakes in long horizontal and multilateral wells is a difficult, but very important task. Both mechanical approaches such as water jetting, and chemical means such as acids, oxidizers, and enzymes, have been used in the field with limited success. Conventional chemical treatments for removing filtercake from the wellbore typically involve placing aqueous breaker solutions in contact with the filtercake, followed by a chemical soak. These treatments may use oxidizers, mineral and/or organic acids, chelating agents, enzymes or a combination. Generally, the oxidizer or enzyme breakers digest the polymer layer in the filtercake, and when the solids in the filtercake are soluble such as carbonate, the chelants and acids dissolve the solid portion of the filtercake. These methods have serious limitations, which can adversely affect well performance. Acids and oxidizers are non-specific, and are very reactive, because of which uniform treatment of long intervals is very difficult.

Benefits potentially associated with enzymes include polymer specificity, autocatalysis which means just small amounts can be effective, and a better health, safety and environmental (HSE) profile than chemical catalysts and oxidizers. Enzymes can be higher in molecular weight than oxidative breakers so that they tend not to leak off into the surrounding formation, and can also be less susceptible to dramatic changes in activity by trace contaminants. Enzymes can be used to degrade starch and xanthan polymers and can facilitate uniform treatment of the filter cake induced damage. For example, well treatment fluids for gravel packing, available under the trade designation MudSOLV™ and described in U.S. Pat. No. 6,638,896 and U.S. Pat. No. 6,140,277, use a gravel carrying fluid containing enzyme for polymer removal in filter cake remediation, chelating agent to dissolve carbonate, and a cationic or non-ionic viscoelastic surfactant (VES) system at a sufficiently high concentration to viscosify the fluid.

However, enzymes used in conventional filter cake removal can lose suitable enzymatic activity at downhole conditions and/or can coagulate, flocculate or char, before a sufficient period of time has elapsed that is adequate for the enzyme to break the polymer. For oilfield applications, enzyme reaction times are usually at least 4 hours at temperature. Activity of the enzyme, or the ability of the enzyme to catalyze breaking of the polymer by hydrolysis, for example, is of course important, but because the enzyme is a catalyst rather than a reactant which would otherwise be consumed in the breaking reaction, sometimes just a small amount of active enzyme can be effective where the enzyme concentration is not rate-limiting. Coagulated enzyme, for example, may have some very limited activity, although it is usually difficult to achieve necessary enzyme coagulant-substrate contact for adequate effectiveness. Another issue with enzyme coagulation is that the residue can accumulate on the surface of the filtercake, resulting in a thin film that can lower the permeability of the filtercake even further.

Enzymes can be extremely sensitive to pH, ionic strength and temperature. Enzymes are not normally effective in breaking polymers in acidic solutions. High salinity, especially in the presence of divalent ions like calcium, can also prematurely inactivate and/or coagulate enzymes.

Enzymes begin to lose their activity at higher temperatures, e.g. above 4° C. (40° F.). A major limitation of enzymes is their inability to stay active at temperatures above 93° C. (200° F.). For example, experimental studies reported in the literature show that the activity of enzymes at 97° C. (207° F.) is less than 10% of activity at 93° C. (200° F.). Although there can be variations in their activity at the upper temperature limit depending on the source of the enzyme, one α-amylase has been effective at degrading starch at temperatures up to 90° C. (194° F.) but not 100° C. (212° F.).

Enzymes can flocculate and char when heated above 93° C. (200° F.). Above about 60° C. (140° F.), amylase may begin to coagulate, and coagulation is severe after just 15 minutes at 71° C. (160° F.). For an improved enzyme breaker, oilfield applications generally seek applicability across a broader pH, salinity, and temperature range, e.g. above 93° C. (200° F.), above 107° C. (225° F.), or even above 121° C. (250° F.); storability without refrigeration, e.g. at or above ambient temperature; improved logistics; and easy mixing.

The temperature dependence of enzymes must be understood to apply them correctly at oilfield conditions. Within its activity range, an enzyme generally speeds up a reaction more as the temperature is increased. However, reactions that deactivate the enzyme, e.g. the denaturation of proteins, are also favored at higher temperatures. Hence, there exists an optimum temperature for a given time and turnover requirement. The temperature limit for use of a given enzyme depends critically on the kinetics of turnover, deactivation, and transport. The faster an enzyme can be brought to the place where it has to do its job, the higher the maximum temperature at which it can be used. Wells with higher bottomhole static temperature may still be treated, depending on the temperature gradient and the process design. In these cases, field treatment procedures must be tuned to bring enzyme to the desired cleanup location downhole at a sufficiently low temperature and for a sufficient time to enable it to degrade the polymer, before the enzyme itself is deactivated and/or coagulated by the heat.

Apar, “Amylase inactivation by temperature during starch hydrolysis,” Process Biochemistry 39 (2004) 1137-1144, reported that the residual α-amylase activity from B. licheniformis decreases as the temperature increases from 50° C. to 60° C. (122° F. to 140° F.) due to inhibitory effects of temperature. Tanaka et al., Biotechnol. Appl. Biochem. (2003) 38, (175-181), discloses that the anionic surfactant sodium dodecyl sulfate in an aqueous solution below its critical micellar concentration accelerated the inactivation and the unfolding of the enzyme structure of B. amyloliquefaciens α-amylase.

The enzyme technology was used in Hanssen et al., “New enzyme process for downhole cleanup of reservoir drilling fluid filtercake,” SPE 50709 (1999), to break down the pH modifier using a non-thermal mechanism, thus allowing product deployment at low temperatures previously unavailable to thermal degradation systems, e.g. inducing scale inhibitor precipitation at 40° C. (104° F.) and 80° C. (176° F.).

Proteins adapted to extremely high temperatures, known as thermozymes, are produced by thermophilic or hyperthermophilic organisms living at temperatures ranging from 70° C. (158° F.) to far above 100° C. (212° F.). They remain folded and functional at elevated temperatures, and they are often less active at lower temperatures. In contrast to this, their mesophilic homologues, having a very similar structure and a high sequence homology, may keep their specific conformation and their functionality only up to approximately 60° C. (140° F.). The thermozymes have some structural properties which have been related to increase thermostability, e.g., additional hydrogen bonds and salt bridges, shorter loop regions, increased internal hydrophobicity, as well as some dynamic features that also play a crucial role for thermal adaptation. See Wallon et al., J. Mol. Biol. 266 (1997) 1016.

U.S. Pat. No. 5,247,995 discloses enzymes specific to a particular type of polysaccharide such as galactosidase and mannosidase, which are said to be active at 90° C. and a pH from 2 to 10. U.S. Pat. No. 4,243,546 discloses proteases and α-amylases in anionic and non-ionic detergent formulations stabilized with organic acids and ethanolamines. U.S. Pat. No. 5,719,039 discloses an ion pair complex of an enzyme and an anionic or cationic surfactant in an organic solvent. Viparelli, Biochem J., 344 (Pt 3), 765-773 (Dec. 15, 1999) discloses models for enzyme superactivity in aqueous solutions of surfactants. Other background references include U.S. Pat. No. 5,566,759, U.S. Pat. No. 6,110,875, U.S. Pat. No. 5,678,632, U.S. Pat. No. 6,763,888, U.S. Pat. No. 4,741,401 and U.S. Pat. No. 5,103,905.

Extending the temperature envelope in which the enzyme breakers can remain effective can offer operational and economic benefits. The discovery of a way to package the enzyme in a dry or encapsulated form, or in an aqueous form without refrigeration, without loss of activity, can also enhance wellsite delivery and add value for logistics and storage stability.

### SUMMARY OF THE INVENTION

We have found that water-soluble amphoteric surfactants can be used as temperature extenders to thermostabilize enzymes in aqueous systems such as brine in one embodiment, especially high brines with a high saline content. In one embodiment, amphoteric surfactants can be used to stabilize enzymes in aqueous solutions. The thermostabilization of enzymes with surfactants allows the enzymes to be stored and shipped as solids, gels and stable aqueous solutions that do not require refrigeration to retain activity over extended periods of time. In addition, the thermostabilized mesophilic enzymes can be used to digest polymers at temperatures that have heretofore not been possible with the particular enzyme, e.g. greater than 100° C. (212° F.) in one embodiment, for example, in oilfield applications in various embodiments, such as filtercake removal, fracturing fluids, and other polymer breaker applications, and the like. The thermostabilized enzymes can also facilitate polymer digestion in high brine systems. Further, the surfactants can be effective temperature extenders at relatively low concentrations, for example, at 0.5 to 3 volume percent in one embodiment.

In one embodiment, the present invention can provide an enzyme system useful as a well treatment fluid for downhole polymer degradation. The system can include a brine carrier fluid, preferably a high brine carrier fluid, defined herein as having a specific gravity greater than 1.02 (8.5 lb/gal); a miscible enzyme; and an amphoteric surfactant in an amount effective to thermally stabilize the enzyme in the carrier fluid. In embodiments, the carrier fluid can include an inorganic salt and have a solution specific gravity above 1.14 (9.5 lb/gal), or at least 1.32 (11 lb/gal).

In an embodiment, the enzyme can be selected from the enzyme classes oxidoreductases (EC 1), hydrolases (EC 3), lyases (EC 4), and the like, and combinations thereof. For examples of enzyme subclasses, the enzyme can be a peroxidase (EC 1.11), esterase (EC 3.1), glycosylase (EC 3.2), carbon-oxygen lyases (EC 4.2) or a combination thereof. In a preferred embodiment, the enzyme can be selected from amylases, cellulases, galactosidases, hemicellulases, mannanases, pectinases, xanthanases, and combinations thereof, especially amylase such as α-amylase.

In an embodiment, the amphoteric surfactant can have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

wherein R is an alkyl group that can contain from about 11 to about 25 carbon atoms which may be branched or straight chained and which may be saturated or unsaturated; a, b, a′, and b′ can each be from 0 to 10 and m and m′ can each be from 0 to 13, a and b can each be 1 or 2 if m is not 0 and (a+b) is from 2 to 10 if m is 0; a′ and b′ can each be 1 or 2 when m′ is not 0 and (a′+b′) can be from 1 to 5 if m′ is 0; (m+m′) can be from 0 to 14; and CH₂CH₂O may also be OCH₂CH₂.

In another embodiment, the surfactant can be a betaine having an alkyl or alkylamido group of from 12 to 17 carbon atoms.

In one embodiment, the enzyme system can have a weight ratio of the enzyme to surfactant from 1:5 to 5:1. In another embodiment, the surfactant can be present at from 0.01 weight percent up to 3 weight percent, by weight of the carrier fluid.

In another embodiment, the enzyme system can have a viscosity at 25° C. and 100 sec⁻¹ of less than 50 mPa-s. In another embodiment, the system can include a polymeric thickener. In a further embodiment, the thickener is a degradation substrate for the enzyme.

In an embodiment, the enzyme system can include buffering at a pH from 2 to 9.5.

In an embodiment, the surfactant can also inhibit coagulation of the enzyme.

In another embodiment, the present invention can provide a method of digesting a polymer with an enzyme in high brine. The method can include preparing a mixture of the enzyme and a stabilizing amount of an amphoteric surfactant in high brine having a specific gravity greater than 1.02 (8.5 lb/gal), and contacting the polymer with the mixture at a temperature above 100° C. wherein the enzyme is active in the presence of the surfactant to degrade the polymer. In one embodiment of the method, the degradation temperature can be above 120° C. In another embodiment of the method, the polymer can be a polysaccharide and the enzyme α-amylase.

In an embodiment of the method, the surfactant has the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

wherein R is an alkyl group that contains from about 11 to about 16 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂.

In another embodiment, the invention provides a well treatment method for downhole degradation of polymer. This method can include preparing a well treatment fluid comprising amylase and an amphoteric surfactant in a high brine carrier fluid having a specific gravity of at least 1.02 (8.5 lb/gal), preferably at least 1.14 (9.5 lb/gal), and more preferably at least 1.32 (11 lb/gal), wherein the surfactant comprises an alkyl or alkylamido group of from 11 to 17 carbon atoms, wherein a weight ratio of the enzyme to surfactant is from 1:5 to 5:1, wherein the brine comprises an inorganic salt; and pumping the well treatment fluid downhole in contact with a polysaccharide for a period of time and at a temperature effective to at least partially degrade the polysaccharide. In an embodiment, the degradation temperature is above 100° C., preferably above 120° C.

In another embodiment of the well treatment method, the surfactant comprises the betaine structure:

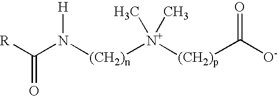

wherein R is a hydrocarbon group that may be branched or straight chained, aromatic, aliphatic or olefinic and has from 10 to 16 carbon atoms, and may contain an amine; n=about 2 to about 4; and p=1 to about 5, and mixtures of these compounds.

In one embodiment, the polysaccharide can be in a filtercake contacted by the well treatment fluid.

In another embodiment, the pumping can include transporting proppant or gravel slurried in the well treatment fluid. Further, the well treatment fluid can include a polymeric thickener, and the method can include degradation of the thickener by the enzyme following the proppant or gravel transport.

### BRIEF DESCRIPTION OF DRAWINGS

FIG. 1 plots the viscosity profile of a starch solution at 107° C. (225° F.) and 121° C. (250° F.) with α-amylase enzyme added at 125 minutes, and shows that the enzyme is active to digest the starch and lower the solution viscosity at the lower temperature, but is inactivated at the higher temperature.

FIG. 2 plots the viscosity profile of a starch solution at 121° C. (250° F.) with α-amylase enzyme added at 125 minutes with and without an amphoteric surfactant, showing that the surfactant has a thermostabilizing effect on the enzyme and increases the temperature envelope at which it can be used as a polymer breaker.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

In one embodiment, the present invention provides a high temperature enzymatically active fluid that can include an aqueous mixture of a soluble, mesophilic polymer-breaking enzyme and a temperature extender in an amount effective to increase thermal stability of the enzyme in the aqueous medium. As used herein, a polymer “breaker” broadly encompasses materials such as enzymes that catalyze or otherwise mediate a reaction or reactions that degrade or reduce the molecular weight of the polymer, as well as materials that are reactants in the polymer breaking reaction or reactions, which materials may or may not be consumed or inactivated in the polymer breaking reaction.

The enzyme may be any oxidoreductase, hydrolase or lyase, especially hydrolase, soluble in water capable of degrading polymeric substrates, especially the types of polysaccharides used in filtercakes, fracturing and blocking gels, as well as in other applications in the oil and gas industry, albeit at low to moderate temperatures. As used herein, enzyme classification (EC), subclasses and related terminology follow the Recommendations of the Nomenclature Committee of the International Union of Biochemistry and Molecular Biology on the Nomenclature and Classification of Enzymes by the Reactions They Catalyze, as reported in Enzyme Nomenclature 1992, Academic Press, San Diego, Calif. (1992) and its supplements to date. Hydrolases do not usually require co-enzymes, which is a considerable advantage. The enzymes can include, for example, cellulases, hemi-cellulases, pectinases, xanthanase, mannanase, α-galactosidase, amylase and the like, and mixtures thereof. Amylases can include α-, β- and γ-amylases, especially α-amylases.

Enzymes are specific to degrade the particular linkages found on the polymer backbone, such as the 1,4-linkage between mannose in galactomannans in the case of mannanases, at particular temperature ranges where the enzyme is active. See, for example, U.S. Pat. No. 5,067,566; U.S. Pat. No. 5,201,370; U.S. Pat. No. 5,224,544; U.S. Pat. No. 5,226,479; U.S. Pat. No. 5,247,995; U.S. Pat. No. 5,421,412; U.S. Pat. No. 5,562,160; and U.S. Pat. No. 5,566,759.

Xanthanases, for example, can degrade xanthan-containing materials at low to moderate temperatures of up to about 66° C. (150° F.), but can be less effective at temperatures above about 66° C. (150° F.). The present invention in one embodiment is particularly advantageous in connection with thermally unstable enzymes, referred to herein as “mesophilic” enzymes, that are active and stable in brine at relatively low temperatures, but denature or substantially lose activity at an elevated temperature, especially where thermal stability is needed at an elevated temperature above about 60° C., 80° C., 90° C., 100° C., 107° C., or 120° C., or higher. Most α-amylases, for example, are known to denature in high brines at a relatively low temperature and as a result heretofore could not be viably used in downhole environments at higher temperatures.

In an embodiment, the aqueous medium of the enzyme system includes a high brine, defined herein as having a solution specific gravity greater than 1.02 (8.5 lb/gal), based on the weight of the liquid phase of the aqueous solution, i.e. exclusive of any entrained or dispersed insoluble solids or gas bubbles. In embodiments, the high brine can have a solution specific gravity above 1.14 (9.5 lb/gal), preferably at least 1.32 (11 lb/gal). An upper limit of brine density in one embodiment corresponds to saturation at the solubility limit of the salt dissolved in the carrier fluid. The salt contained in the high brine preferably includes potassium chloride, sodium chloride, calcium chloride, or a combination thereof, but can also be any mineral or organic salts or compounds susceptible to modify the ionic strength of the high brine. In one embodiment, the enzyme-surfactant system can include a dissolved salt comprising a divalent ion such as calcium, and in another embodiment the divalent ion is present at a concentration that would normally result in inactivation and/or coagulation of the enzyme in the absence of the surfactant at the temperature and other conditions of use. Stated differently, the surfactant can be present in embodiments of the enzyme system as an ionic strength extender, especially a divalent ion strength extender, to allow use of the enzyme at higher salinity and/or higher divalent ion concentrations than would otherwise be possible.

The polymers which can be digested with the stable enzyme formulation of the invention depend on the particular enzyme employed. Typical polymers used in filtercake formation in the oil and gas industry can include polysaccharides such as starch, galactomannans such as guar, derivatized guars such as hydroxypropyl guar, carboxymethyl guar, carboxymethyl-hydroxypropyl guar, hydrophobically modified galactomannans, xanthan gum, cellulose, derivatized cellulose such as hydroxyethylcellulose, and polymers, copolymers and terpolymers containing acrylamide monomer, and the like. The polymers can also be crosslinked with, for example, metal ions such as borate, zirconium or titanium including complexed metals, and so on. A particular embodiment of the invention can be especially useful in removing polymer which is resistant to other removal techniques, e.g. in many cases where the polymer is a titanium or zirconium crosslinked gel or other system that is operable at low pH and/or resistant to acid breaking.

In one embodiment, the temperature extender can be an amphoteric surfactant. In general, preferred amphoteric surfactants in one embodiment have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 10 to about 27 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂.

Preferred amphoteric surfactants in one embodiment include the betaines. BET and other surfactants are described in U.S. Pat. No. 6,258,859. In one embodiment, the surfactant has the betaine structure:

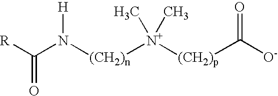

wherein R is a hydrocarbon group that may be branched or straight chained, aromatic, aliphatic or olefinic and has from 10 to 27 carbon atoms, preferably from 10 to 16 carbon atoms, and may contain an amine; n=about 2 to about 10, preferably from 2 or 3 up to 4 or 5; and p=1 to about 5, preferably from 1 to 3, and mixtures of these compounds.

Two examples of betaines are oleylamidopropyl betaine (BET-O) and erucylamidopropyl betaine (BET-E). The surfactant designations BET-O and BET-E are sometimes suffixed with a two digit numeral to indicate the percentage of active surfactant in a solution, e.g. MIRATAINE BET-O-30 obtained from Rhodia, Inc. Cranbury, N.J., USA, contains about 30% by weight active surfactant containing an oleyl acid amide group, including a C₁₇H₃₃ alkene tail group, in a solution that the remainder of which is substantially water, sodium chloride, and propylene glycol. Similarly, BET-E-40 contains an erucic acid amide group, including a C₂₁H₄₁ alkene tail group, and is approximately 40% active ingredient by weight, with the remainder being substantially water, sodium chloride, and isopropanol.

In one embodiment, the amphoteric surfactant has a relatively short long-chained alkyl or alkylamido group, i.e. from 11 to 17 carbon atoms. Although not wishing to be bound by theory, it is believed that the smaller hydrophobic tail group benefits from improved hydrophilicity and/or water solubility of the surfactant and facilitates dispersion of the enzyme.

The amphoteric surfactants are used at a concentration of about 0.1 to 2 percent by weight of the liquid phase of the treatment fluid. These surfactants are generally available as 20 to 50 weight percent liquid surfactant concentrates, and thus the surfactant concentrate can be used at from 0.2 to about 10 weight percent of the as-received surfactant concentrate by weight of the liquid phase of the treatment fluid, preferably from about 0.5 to about 2, 2.5, or 3 weight percent of the as-received surfactant concentrate by weight of the liquid phase of the treatment fluid.

Co-surfactants may be used with BET surfactants, e.g. to increase the brine tolerance, in particular for BET-O-type surfactants. An example given in U.S. Pat. No. 6,258,859 is sodium dodecylbenzene sulfonate (SDBS). Other suitable co-surfactants include, for example, alkylbenzene sulfonates in which the alkyl group has 5 to 15 carbon atoms, especially 7 to 15 carbon atoms. Still other suitable co-surfactants for the betaines are certain chelating agents such as trisodium hydroxyethylethylenediamine triacetate. The temperature extenders of the present invention may be used with enzyme solutions that contain such additives as co-surfactants, organic acids, organic acid salts, and/or inorganic salts.

Other exemplary classes of amphoteric surfactants include those described in U.S. Pat. No. 6,703,352, for example amine oxides, and in US Publications 2002/0147114, 2005/0067165, and 2005/0137095, for example amidoamine oxides. Mixtures of amphoteric surfactants are commercially available, such as, for one example, a concentrated mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

Treatment fluids, for example those used in the oilfield, may also contain agents that dissolve minerals and compounds, for example in formations, scale, and filtercakes. When the enzyme is not denatured by strong acids, such agents may be, for example, hydrochloric acid, formic acid, acetic acid, lactic acid, glycolic acid, sulfamic acid, malic acid, citric acid, tartaric acid, maleic acid, methylsulfamic acid, chloroacetic acid, aminopolycarboxylic acids, 3-hydroxypropionic acid, polyaminopolycarboxylic acids, for example trisodium hydroxyethylethylenediamine triacetate, and salts of these acids and mixtures of these acids and/or salts. For sandstone treatment, the fluid can also typically contain a hydrogen fluoride source. The hydrogen fluoride source may be HF itself or may be selected from ammonium fluoride and/or ammonium bifluoride or mixtures of the two; when strong acid is present the HF source may also be one or more of polyvinylammonium fluoride, polyvinylpyridinium fluoride, pyridinium fluoride, imidazolium fluoride, sodium tetrafluoroborate, ammonium tetrafluoroborate, and salts of hexafluoroantimony. When the formation-dissolving agent is a strong acid, the fluid preferably contains a corrosion inhibitor. The fluid optionally contains chelating agents for polyvalent cations, for example especially aluminum, calcium and iron (in which case the agents are often called iron sequestering agents) to prevent their precipitation. Some of the formation-dissolving agents just described are such chelating agents as well. Chelating agents are added at a concentration, for example, of about 0.5 weight % (of active ingredient in the liquid phase).

In one embodiment, especially where a neutral pH is desired at least initially where the enzyme may be sensitive to low pH conditions, a solid acid precursor can alternatively or additionally be used to form acid in situ to dissolve the acid-soluble constituents in the filtercake or formation. Suitable solid acid precursors can include lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures thereof. The solid acid precursors are described, for example, in U.S. Pat. No. 7,166,560.

In addition, the soluble enzyme or enzyme solution can be encapsulating for storage, transportation and/or use, e.g. to influence activity and/or deposition of the enzyme. For example, U.S. Pat. No. 4,506,734 discloses a breaker within hollow beads, wherein the breaker is activated when the beads are crushed during fracture closure. Moreover, US 20060278389 provides a fluid loss additive (FLA) containing a breaker system that can be deposited adjacent the filter cake.

The aqueous mixture for the filtercake removal can be prepared by mixing (a) the soluble enzyme provided in either solid or liquid form, removing the encapsulant where necessary, with (b) the temperature extender, and (c) any other components in water or brine in any order.

Contacting the filter cake with the mixture can be achieved by contacting the filter cake with the enzyme-surfactant mixture at conditions of temperature, pH, etc., and for a time effective to degrade the filtercake, using equipment and methodology known by the skilled artisan for this purpose. For example, in gravel pack and screen-only completions, the enzyme-surfactant mixture can be spotted or otherwise placed in contact with the wellbore surface where the filtercake is to be removed. In gravel pack applications, the enzyme-surfactant mixture can be used to transport the gravel, or can be used as a post-soak after the gravel is placed using another transport fluid.

Filtercake typically includes polymers, carbonates and other inorganic salts and clays. An embodiment can be useful in removing any polymer which can be digested by an enzyme. The temperature range at which the enzyme can digest the polymer can be extended, via a chemical additive, to temperatures which are otherwise too hot for the unaided enzyme to remain active. Another embodiment can generate acid from a solid acid precursor to dissolve the carbonate or other acid-reactive components of the filter cake.

The invention, accordingly, provides the following embodiments:
A. An enzyme system useful as a well treatment fluid for downhole polymer degradation, comprising a mixture of: a brine carrier fluid; a miscible enzyme; and an amphoteric surfactant in an amount effective to thermally stabilize the enzyme in the carrier fluid.
B. The enzyme system of embodiment A wherein the carrier fluid comprises high brine comprising an inorganic salt and having a specific gravity of at least 1.02 (8.5 lb/gal), preferably at least 1.14 (9.5 lb/gal), or more preferably at least 1.32 (11 lb/gal).
C. The enzyme system of either of embodiment A or embodiment B wherein the enzyme is selected from the group consisting of oxidoreductases (EC 1), hydrolases (EC 3), lyases (EC 4) and combinations thereof.
D. The enzyme system of any preceding embodiment A through C wherein the enzyme is selected from the group consisting of peroxidases (EC 1.11), esterases (EC 3.1), glycosylases (EC 3.2), carbon-oxygen lyases (EC 4.2) and combinations thereof.
E. The enzyme system of any preceding embodiment A through D wherein the enzyme is selected from the group consisting of amylases, cellulases, galactosidases, hemicellulases, mannanases, pectinases, xanthanases, and combinations thereof.
F. The enzyme system of any preceding embodiment A through E wherein the enzyme comprises amylase.
G. The enzyme system of any preceding embodiment A through F wherein the surfactant has the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

wherein R is an alkyl group that contains from about 11 to about 25 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂.
H. The enzyme system of any preceding embodiment A through G wherein the surfactant comprises betaine having an alkyl or alkylamido group of from 12 to 17 carbon atoms.
I. The enzyme system of any preceding embodiment A through comprising a weight ratio of the enzyme to surfactant from 1:5 to 5:1.
J. The enzyme system of any preceding embodiment A through I wherein the surfactant is present at from 0.01 weight percent up to 3 weight percent, by weight of the carrier fluid.
K. The enzyme system of any preceding embodiment A through J comprising a viscosity at 25° C. and 100 sec⁻¹ of less than 50 mPa-s.
L. The enzyme system of any preceding embodiment A through K further comprising a polymeric thickener.
M. The enzyme system of embodiment L wherein the thickener is a degradation substrate for the enzyme.
N. The enzyme system of any preceding embodiment A through M comprising buffering at a pH from 2 to 9.5.
O. The enzyme system of any preceding embodiment A through N wherein the surfactant further inhibits coagulation of the enzyme.
P. A method of digesting a polymer with an enzyme in high brine, comprising: preparing the enzyme system of any preceding embodiment A through 0; and contacting the polymer with the mixture at a temperature above 40° C. wherein the enzyme is active in the presence of the surfactant to degrade the polymer.
Q. The method of embodiment P wherein the degradation temperature is above 100° C. or preferably above 120° C.
R. A well treatment method for downhole degradation of polymer, comprising: preparing a well treatment fluid comprising the enzyme system of any preceding embodiment A through 0; pumping the well treatment fluid downhole in contact with a polymer for a period of time and at a temperature effective to at least partially degrade the polymer
S. The well treatment method of embodiment R wherein the degradation temperature is above 40° C., preferably above 100° C. or more preferably above 120° C.
T. The well treatment method of either embodiment R or embodiment S wherein the polymer comprises polysaccharide.
U. The well treatment method of any preceding embodiment R through T wherein the polymer is in a filtercake contacted by the well treatment fluid.
V. The well treatment method of any preceding embodiment R through U wherein the pumping comprises transporting proppant or gravel slurried in the well treatment fluid.
W. The well treatment method of embodiment V wherein the well treatment fluid comprises a polymeric thickener and further comprising degradation of the thickener by the enzyme following the proppant or gravel transport.
X. The well treatment method of any preceding embodiment R through W wherein the surfactant comprises the betaine structure:

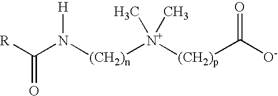

wherein R is a hydrocarbon group that may be branched or straight chained, aromatic, aliphatic or olefinic and has from 10 to 16 carbon atoms, and may contain an amine; n=about 2 to about 4; and p=1 to about 5, and mixtures of these compounds.

The following examples are presented to illustrate the preparation and properties of some embodiments of the invention, and should not be construed to limit the scope of the invention, unless otherwise expressly indicated in the appended claims. All percentages, concentrations, ratios, parts, etc. are by weight unless otherwise noted or apparent from the context of their use.

### EXAMPLES

### Example 1

Enzyme solutions were prepared with varying amounts of temperature extender, and clear bottles containing the solutions were placed in a thermostatically controlled water bath at 82° C. (180° F.) for visual inspection. The enzyme was α-amylase obtained as an aqueous solution from Genencor or Novozyme and was used in the prepared solutions at 0.5 volume percent. The temperature extender was BET-E surfactant obtained as a 40 weight percent solution, and was used in the prepared solutions at 0, 0.1, 0.25, 0.5, 0.75 and 1 volume percent. The enzyme solutions were buffered to pH 9.0 with alkaline buffers.

At 0 and 0.1 vol % surfactant solution, the enzyme was precipitated into a large mass. At 0.25 vol % surfactant solution, the enzyme was precipitated into a slightly smaller mass and the supernatant was clear, indicating that a small portion of the enzyme stayed dissolved in the solution. At 0.5 vol % surfactant solution, only a very small amount of floc was visible, but the enzyme largely remained in the clear solution. At 0.75 and 1 vol % surfactant solution, there was no visible precipitate and the enzyme appeared to stay in the clear solution.

It is noted that the BET-E surfactant is not considered to be very soluble in water. The presence of flocculation indicated that the enzyme was unsuitable at the temperature either because of denaturation or at least a drop in enzyme efficiency on the order of 90%; however, the absence of a precipitate does not necessarily demonstrate that the enzyme is still fully functional. A qualitative starch iodine test indicated that the enzyme in the presence of surfactant had a better starch dissolving power. Based on these data, and the desire to use the least amount of surfactant at which the enzyme is adequately thermostabilized, the BET-E surfactant solution should be used with the enzyme at this temperature at a concentration of at least about 0.5 vol % of the as-received surfactant solution by volume of the liquid phase of the treatment fluid.

### Example 2 (Comparative)

Experiments were performed to determine if enzyme activity temperature range could be extended to above boiling without a chemical additive stabilizer. A flow loop equipped with a rheometer was used in a series of runs to measure the real-time viscosities of stock starch solutions, 28.5 g/L (10 lb/bbl) starch in NaCl brine having a density of 1.14 g/L (9.5 lb/gal) at a pH of 7, at two different temperatures, 107° C. (225° F.) and 121° C. (250° F.) at 2.76 MPa (400 psi). Each of the three runs included an injection at 125 minutes of α-amylase enzyme only to the respective starch solution. The enzyme was received as a 2 wt % aqueous solution and was injected into the stock starch solution at 1.0 volume percent by volume of the liquid phase of the starch solution. The activity of the enzyme could be observed by a reduction in the viscosity of the starch solution, or the inactivity by an absence of viscosity reduction.

Fluid viscosity measurements were performed with a fully automated high-pressure-high-temperature (HPHT) capillary rheometer, Chandler-Schlumberger Foam Rheometer System. The system was designed for evaluating foamed fluids, but was used in these examples with a straight liquid (unfoamed) without energizing gas. Details on the operation of the equipment are reported in Hutchins, SPE 80242 (2003). The equipment was calibrated in compliance with ISO-9001 standards. The rheometer included a 416-mL closed flow loop. The equipment was provided with a mass flowmeter, Micro Motion ELITE CMF010 sensor provided with model 2700 transmitter, both available from Emerson Process Management of 7070 Winchester Circle, Boulder, USA 80301, that determined flow rate and density of the fluid. The measured flow rate was used to determine the working speed of a positive displacement pump, Series 220 available from Micropump, Inc. of 1402 NE 136th Avenue, Vancouver, USA 98684-0818, that was needed to achieve the shear rate indicated by the user through a software interface, Chandler FoamLoop DACS v.1.12.1, available from Chandler Engineering of 2001 Indianwood Avenue Broken Arrow, USA 74012-1163. The pressure drop along a 6.1 meter long 6.4 millimeter outside diameter stainless steel tubing was measured with a pressure transducer, a Rosemount model 3051 available from Emerson Process Management, to determine the apparent viscosity. The software calculated shear rate and apparent viscosity using equations based on fluid mechanic principles, see Hutchins, above. Temperature was set through the software, which controlled the operation of an oven, model MO1440SC from Lindberg/Blue of 308 Ridgefield Ct, Asheville, USA 28806, in which most of the tubing was enclosed. Temperature was uniformly maintained in sections of the tubing outside the oven with an electrical heat tracing system model TBX4LC-HPC available from Thermon of 100 Thermon Dr., San Marcos, Tex., USA 78666. The gas/liquid composition of the fluid (0% foam quality in all cases) was verified through the measured density. In all cases, experiments were performed at the stated temperature 107° C. (225° F.) or 121° C. (250° F.) and pressure of about 2.76 MPa (400 psig).

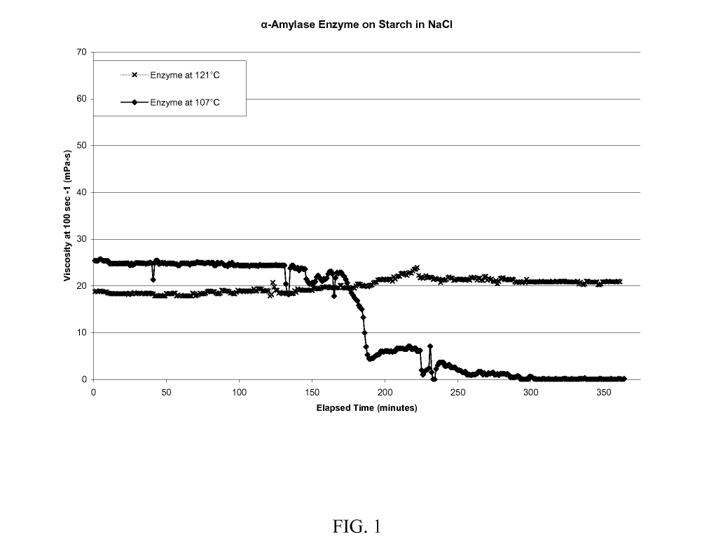

The results shown in FIG. 1 indicate that the enzyme was active to break the starch solution at 107° C. (225° F.), but at 121° C. (250° F.) the temperature exceeded the temperature envelope of the enzyme under the conditions tested.

### Example 3

Example 2 was repeated at 121° C. (250° F.) to determine if the enzyme activity temperature range could be extended above the established temperature envelope with a chemical additive stabilizer. The flow loop described in Example 2 was used in a series of runs to measure the real-time viscosities of stock starch solutions, 71.3 g/L (25 lb/bbl) starch in NaCl brine having a density of 1.14 g/L (9.5 lb/gal) at a pH of 7, at 2.76 MPa (400 psi) and 121° C. (250° F.). Each of the runs included an injection at 125 minutes to the respective starch solution of either α-amylase enzyme only (a 2 wt % aqueous solution injected into the stock starch solution at 1.0 volume percent by volume of the liquid phase of the starch solution) or the enzyme and a betaine amphoteric surfactant (25-35 wt % solution injected at 0.5 volume percent by volume of the liquid phase of the starch solution). The activity of the enzyme could be observed by a reduction in the viscosity of the starch solution, or the inactivity by an absence of viscosity reduction.

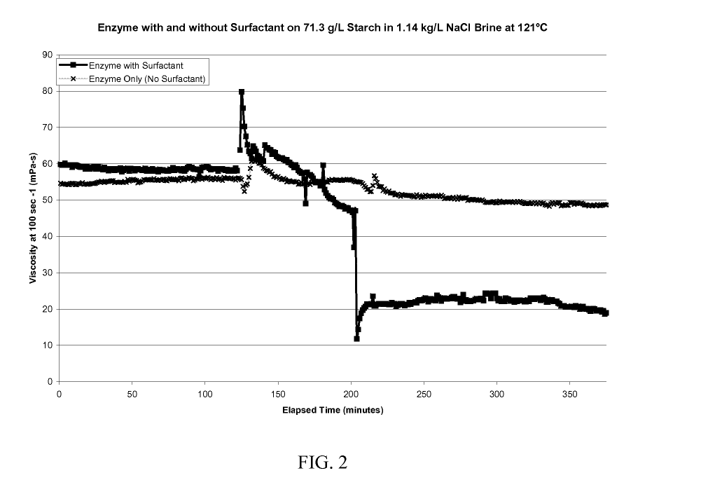

As seen from the results presented in FIG. 2, the presence of the surfactant extended the temperature envelope of the activity of the enzyme under the conditions tested to at least 121° C. (250° F.), whereas the control without the amphoteric surfactant did not show good enzyme activity. Another control with the amphoteric surfactant only and no enzyme (not shown), indicated that the amphoteric surfactant by itself did not contribute to viscosity breaking.

Although the methods have been described here for, and are most typically used for, hydrocarbon production, they can also be used in injection wells and for production of other fluids, such as water or brine. The particular embodiments disclosed above are illustrative only, as the invention can be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above can be altered or modified and all such variations are considered within the scope of the invention. Accordingly, the protection sought herein is as set forth in the claims below.

All patents and other documents cited herein are fully incorporated herein by reference to the extent such disclosure is not inconsistent with this invention and for all jurisdictions in which such incorporation is permitted.

What is claimed is:

1. An enzyme system useful as a well treatment fluid for downhole polymer degradation, comprising a mixture of:
a brine carrier fluid;
a miscible enzyme; and
an amphoteric surfactant in an amount effective to thermally stabilize the enzyme in the carrier fluid.

2. The enzyme system of claim 1 wherein the carrier fluid comprises high brine comprising an inorganic salt and having a specific gravity of at least 1.02 (8.5 lb/gal), preferably at least 1.14 (9.5 lb/gal), or more preferably at least 1.32 (11 lb/gal).

3. The enzyme system of claim 1 wherein the enzyme is selected from the group consisting of oxidoreductases (EC 1), hydrolases (EC 3), lyases (EC 4) and combinations thereof.

4. The enzyme system of claim 1 wherein the enzyme is selected from the group consisting of peroxidases (EC 1.11), esterases (EC 3.1), glycosylases (EC 3.2), carbon-oxygen lyases (EC 4.2) and combinations thereof.

5. The enzyme system of claim 1 wherein the enzyme is selected from the group consisting of amylases, cellulases, galactosidases, hemicellulases, mannanases, pectinases, xanthanases, and combinations thereof.

6. The enzyme system of claim 1 wherein the enzyme comprises amylase.

7. The enzyme system of claim 1 wherein the surfactant has the formula:
RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻
wherein R is an alkyl group that contains from about 11 to about 25 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂.

8. The enzyme system of claim 1 wherein the surfactant comprises betaine having an alkyl or alkylamido group of from 12 to 17 carbon atoms.

9. The enzyme system of claim 1 comprising a weight ratio of the enzyme to surfactant from 1:5 to 5:1.

10. The enzyme system of claim 1 wherein the surfactant is present at from 0.01 weight percent up to 3 weight percent, by weight of the carrier fluid.

11. The enzyme system of claim 1 comprising a viscosity at 25° C. and 100 sec⁻¹ of less than 50 mPa-s.

12. The enzyme system of claim 1 further comprising a polymeric thickener.

13. The enzyme system of claim 11 wherein the thickener is a degradation substrate for the enzyme.

14. The enzyme system of claim 1 comprising buffering at a pH from 2 to 9.5.

15. The enzyme system of claim 1 wherein the surfactant further inhibits coagulation of the enzyme.

16. A method of digesting a polymer with an enzyme in high brine, the method comprising:
preparing a mixture of the enzyme and a stabilizing amount of an amphoteric surfactant in high brine having a specific gravity greater than 1.02 (8.5 lb/gal);
contacting the polymer with the mixture at a temperature above 40° C. wherein the enzyme is active in the presence of the surfactant to degrade the polymer.

17. The method of claim 15 wherein the degradation temperature is above 100° C., preferably above 120° C.

18. The method of claim 15 wherein the polymer comprises a polysaccharide and the enzyme comprises amylase.

19. The method of claim 15 wherein the surfactant has the formula:
RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻
wherein R is an alkyl group that contains from about 11 to about 16 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂.

20. A well treatment method for downhole degradation of polymer, comprising:
preparing a well treatment fluid comprising α-amylase and an amphoteric surfactant in a high brine carrier fluid having a specific gravity of at least 1.14 (9.5 lb/gal), preferably at least 1.32 (11 lb/gal), wherein the surfactant comprises an alkyl or alkylamido group of from 11 to 17 carbon atoms, wherein a weight ratio of the enzyme to surfactant is from 1:5 to 5:1, wherein the brine comprises an inorganic salt;
pumping the well treatment fluid downhole in contact with a polysaccharide for a period of time and at a temperature effective to at least partially degrade the polysaccharide.

21. The well treatment method of claim 20 wherein the degradation temperature is above 100° C., preferably above 120° C.

22. The well treatment method of claim 20 wherein the surfactant comprises the betaine structure: 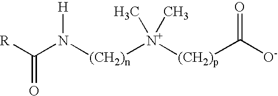
wherein R is a hydrocarbon group that may be branched or straight chained, aromatic, aliphatic or olefinic and has from 10 to 16 carbon atoms, and may contain an amine; n=about 2 to about 4; and p=1 to about 5, and mixtures of these compounds.

23. The well treatment method of claim 20 wherein the polysaccharide is in a filtercake contacted by the well treatment fluid.

24. The well treatment method of claim 20 wherein the pumping comprises transporting proppant or gravel slurried in the well treatment fluid.

25. The well treatment method of claim 24 wherein the well treatment fluid comprises a polymeric thickener and further comprising degradation of the thickener by the enzyme following the proppant or gravel transport.
